(19) United States
(12) Patent Application Publication
(10) Pub. No.: US 2026/0014910 A1
(43) Pub. Date: Jan. 15, 2026

(54) Head Restraint for a Vehicle Seat with a Head Restraint Guide Arrangement and Head Restraint Guide Arrangement for a Head Restraint

(71) Applicant: Illinois Tool Works Inc., Glenview, IL (US)

(72) Inventors: Ferran Garrido Pedregal, Barcelona (ES); Jorge Adolfo Miranda Nieto, Barcelona (ES); David Montes Cobo, Sabadell (ES); Albert Moreno Serra, L'Amettla del Vallès (ES)

(21) Appl. No.: 19/243,486

(22) Filed: Jun. 19, 2025

(30) Foreign Application Priority Data
Jul. 9, 2024 (DE) 10 2024 119 454.5
May 14, 2025 (DE) 10 2025 118 496.8

(51) Int. Cl. B60N 2/815; B60N 2/90

(52) U.S. Cl. CPC B60N 2/815; B60N 2/929; B60N 2002/952

(57) ABSTRACT

The disclosure relates to a headrest for a vehicle seat that includes two rods positioned roughly parallel to each other, which support or can support a head cushion. The headrest also includes a locking mechanism, typically operated by hand, that locks onto only one of the two rods or a section of one rod. This lock features a push button which, when pressed, releases the connection between the locking element and the rod, allowing for adjustment or removal.

### RELATED APPLICATIONS

The present application claims the benefit of German Patent Applications No. 10 2024 119 454.5, filed Jul. 9, 2024, and No. 10 2025 118 496.8, filed May 14, 2025, titled “Head Restraint for a Vehicle Seat with a Head Restraint Guide Arrangement and Head Restraint Guide Arrangement for a Head Restraint,” the contents of which are hereby incorporated by reference.

### BACKGROUND

Head restraints are an essential part of the passive safety system in vehicles and serve to reduce the impact of forces on the cervical spine in the event of a sudden change in vehicle movement, particularly in the event of a traffic accident. In addition to improving the safety of vehicle occupants, headrests also serve to increase comfort.

Headrests are generally designed to be adjustable so that they can perform these functions and be individually adapted to different vehicle occupants in terms of their position. Various designs and variants are known with regard to the adjustment options.

Headrests are usually at least height-adjustable and can be mechanically locked in different positions. For this purpose, the headrests have headrest rods with latching points and a padded support structure (head cushion), which are held in corresponding receptacles in the vehicle seat.

In the case of mechanically adjustable headrests, it is particularly important that the operation and adjustability for a vehicle occupant is quick, easy and can be achieved with little effort, and that an optimal, individual adjustment to different occupants can be achieved. Furthermore, the headrests should be easy and inexpensive to manufacture and install.

Known headrest arrangements, which have a height adjustment in particular, and which are simple to operate, are generally designed with an adjustment mechanism that has a large number of components, for example gear components. This requires a great deal of assembly work and expense.

### SUMMARY

The present disclosure relates generally to a headrest guide and a headrest guide arrangement, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematic and isometric view of a first exemplary embodiment of a headrest guide arrangement of the headrest according to the disclosure.

FIG. 2 illustrates schematic and sectional view of the tolerance compensation used in the exemplary embodiment of the headrest guide arrangement according to the disclosure as shown in FIG. 1.

FIG. 3 illustrates schematic and isometric view of a second exemplary embodiment of a headrest guide arrangement of the headrest according to the disclosure.

FIG. 4 illustrates schematic and isometric view of an exemplary embodiment of the headrest according to the disclosure with a third exemplary embodiment of a corresponding headrest guide arrangement.

FIG. 5 illustrates schematic and isometric exploded view of the embodiment of the headrest according to the disclosure as shown in FIG. 4.

FIG. 6A illustrates schematic and partially sectioned view of the locking mechanism used in the head restraint arrangement according to FIG. 5 in its first state (locking state).

FIG. 6B illustrates the locking mechanism according to FIG. 6A in its second state (unlocked state).

FIG. 7A illustrates schematic and isometric view of an exemplary embodiment of a guide sleeve body of the headrest guide arrangement.

FIG. 7B illustrates schematic and in an isometric exploded view of an exemplary embodiment of a locking device with the exemplary embodiment of the guide sleeve body of the head restraint guide arrangement shown in FIG. 7A.

FIG. 8A illustrates schematic and isometric view of an exemplary embodiment of a guide sleeve body of the headrest guide arrangement (left view) and schematic and isometric view of an exemplary embodiment of a locking mechanism with the guide sleeve body of the headrest guide arrangement (right view).

FIG. 8B illustrates schematic and isometric view of an exemplary embodiment of a guide sleeve body of the headrest guide arrangement (left view) and schematic and isometric view of an exemplary embodiment of a locking mechanism with the guide sleeve body of the headrest guide arrangement (right view).

FIG. 8C illustrates schematic and isometric view of an exemplary embodiment of a guide sleeve body of the headrest guide arrangement (left view) and schematic and isometric view of an exemplary embodiment of a locking mechanism with the guide sleeve body of the headrest guide arrangement (right view).

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to generally adjustable headrest arrangements for a vehicle seat, in particular a motor vehicle seat. In particular, the disclosure relates to head restraints for a vehicle seat with a special head restraint guide arrangement and to a head restraint guide arrangement for such head restraints.

One task of the present disclosure is to provide a headrest arrangement for a vehicle, wherein the headrest can be safely, easily and quickly adjusted to an optimum position for the vehicle occupant and is simple to manufacture and assemble and can be realized at low cost.

Accordingly, the disclosure relates in particular to a headrest for a vehicle seat, wherein the headrest has two headrest rods or headrest rod sections which extend at least substantially parallel and on which a head cushion of the headrest is arranged or can be arranged.

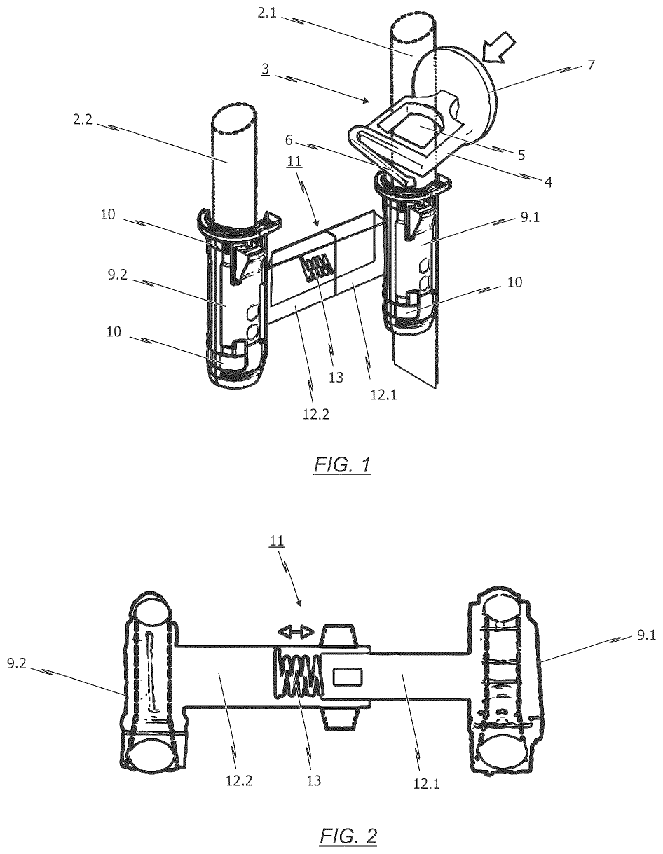

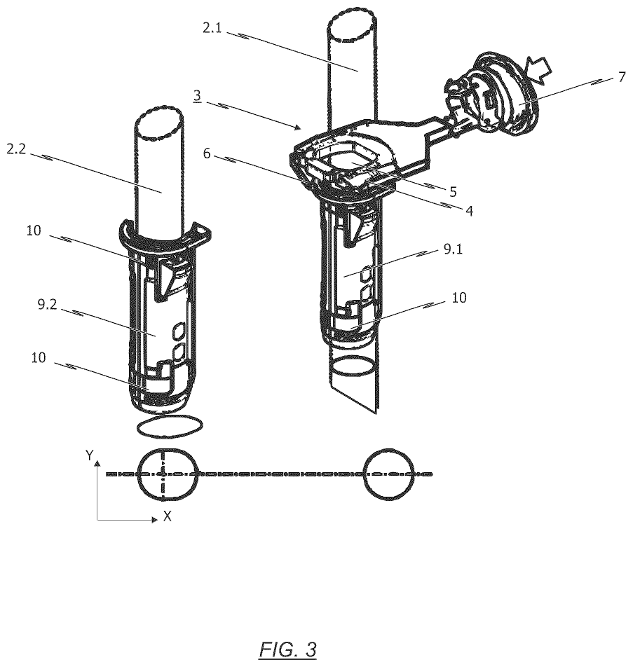

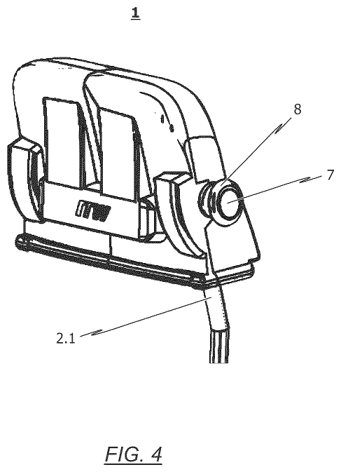

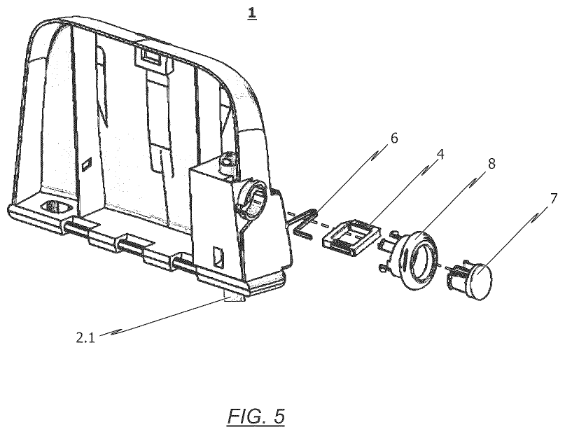

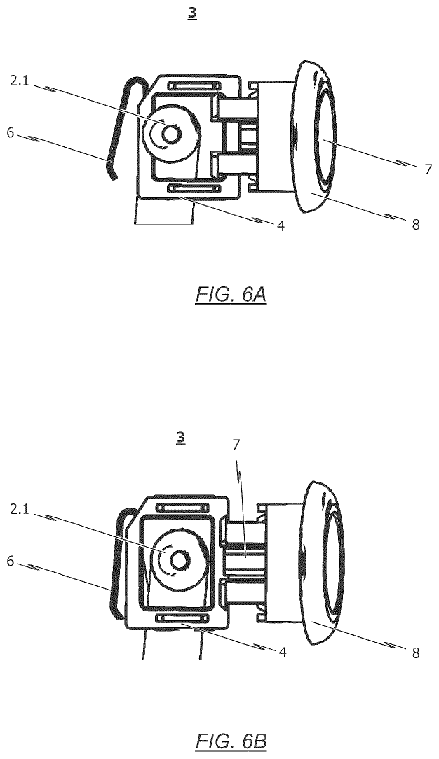

FIGS. 1 through 8C illustrate various schematic and isometric views of exemplary embodiments of a headrest and its guide arrangement according to the disclosure. FIG. 1 illustrates a first embodiment of a headrest guide arrangement, while FIG. 2 illustrates a sectional view highlighting the tolerance compensation used in that embodiment. FIG. 3 illustrates a second embodiment of a headrest guide arrangement. FIG. 4 illustrates a headrest incorporating a third embodiment of the guide arrangement, and FIG. 5 illustrates an exploded isometric view of that same headrest embodiment. FIGS. 6A and 6B illustrate the locking mechanism used in the headrest guide arrangement of FIG. 5, shown in the locked and unlocked states, respectively.

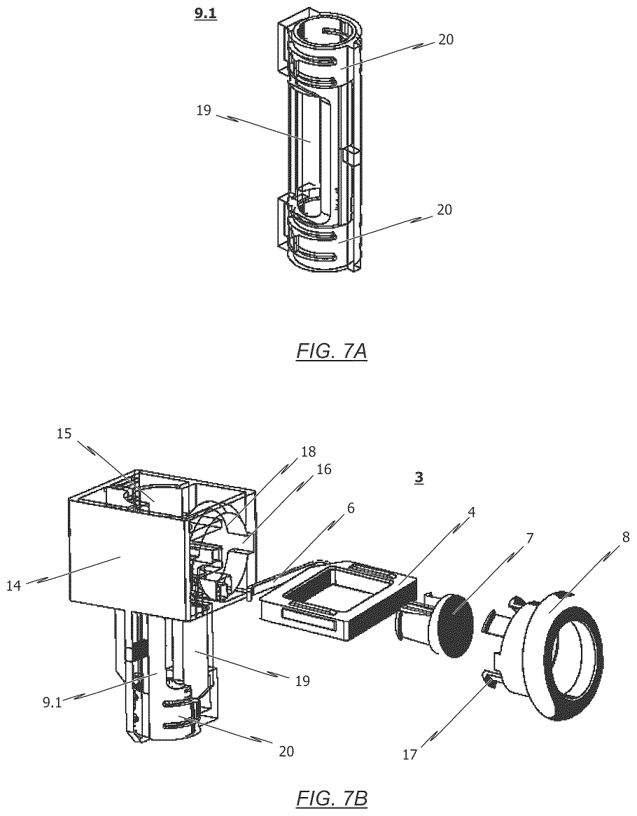

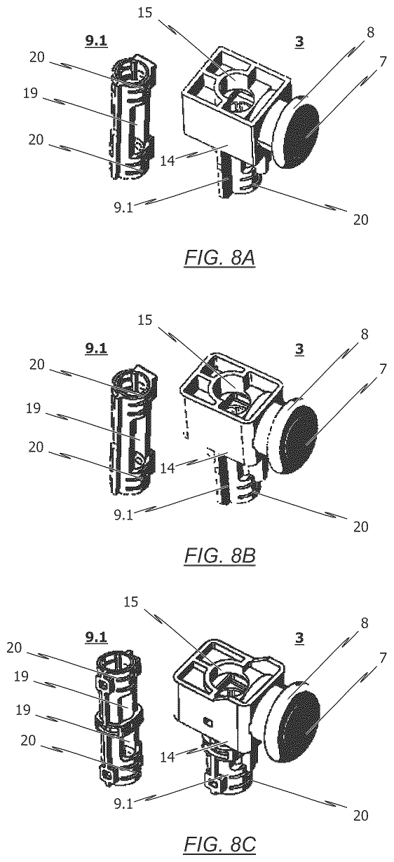

FIGS. 7A and 7B further illustrate details of the guide sleeve body used in the headrest guide arrangement. FIG. 7A illustrates the guide sleeve body on its own, while FIG. 7B presents an exploded view of a locking device in combination with the guide sleeve body. FIGS. 8A through 8C provide additional views of the guide sleeve body and corresponding locking mechanism from different angles, showing how these components interact. Each of these figures contributes to a fuller understanding of the structure and function of the headrest guide and locking system described in the disclosure.

The headrest according to the disclosure further comprises a headrest guide arrangement, by means of which the headrest rods or headrest rod sections are received or can be received on and, in particular, in a seat back of the vehicle seat in such a way that the headrest rods or headrest rod sections are connected to the head cushion of the headrest, which may be arranged on the headrest rods or headrest rod sections, in a longitudinal extension direction of the headrest rods or headrest rod sections. The head restraint rods or head restraint rod sections are adjustable and, in particular, displaceable relative to the head restraint guide arrangement between a first position and at least a second position in a longitudinal direction of the head restraint rods or head restraint rod sections.

To determine an adjustment position of the head restraint, a locking mechanism is used, in particular a manually operated locking mechanism, which can be switched between a first state and a second state. The first state of the locking mechanism corresponds to a locked state in which the adjustability of the headrest rods or headrest rod sections relative to the headrest guide arrangement is blocked. On the other hand, the second locking state corresponds to an unlocked state in which the head restraint rods or head restraint rod sections can be adjusted relative to the head restraint guide arrangement.

The disclosure is characterized in particular by the fact that the locking mechanism, which can be actuated manually in particular, acts exclusively on only one of the two headrest rods or headrest rod sections, especially in its first state.

The fact that the locking mechanism is only assigned to one of the two headrest rods or headrest rod sections simplifies the design of the entire headrest arrangement. In particular, the headrest arrangement can be realized with a particularly small number of components.

According to implementations of the present disclosure, it is provided that the locking device, which can be actuated in particular manually, has an engagement element which, in the first state of the locking device, is in engagement with one of the two headrest rods or with one of the two headrest rod sections. In addition, it is useful for the locking mechanism to have a pretensioning element which pretensions the locking mechanism into its first state.

According to further embodiments of the last-mentioned embodiment variant, it is provided that the locking device, which can be actuated in particular manually, has a pushbutton which is designed in such a way that when the pushbutton is actuated, the locking device is transferred to its second state and an engagement between the engagement element and the one headrest rod or the one headrest rod section is released.

The pretensioning element preferably has a dual function: on the one hand, the pretensioning element serves to pretension the locking mechanism into its first state. On the other hand, the pretensioning element is preferably designed to pretension the push-button into its unactuated position.

Different design variants are possible with regard to the pretensioning element. The pretensioning element is particularly preferably designed as a spring arm that is integral in particular with the engagement element, for example in the form of a V-shaped spring arm that is designed or arranged on a side of the engagement element opposite the pushbutton.

It is conceivable that the engagement element and the pushbutton are designed as a monolithic unit, in particular a plastic injection-molded unit. It is also conceivable that the engagement element, the push-button and the preload element are designed as a single monolithic unit, in particular an injection-molded plastic unit.

However, the present disclosure is not limited to this. It is conceivable, for example, that the push-button is detachably and/or replaceably connected or connectable to the engagement element, in particular via a positive connection, preferably a latching connection.

With regard to the engagement element of the head restraint according to the disclosure, it is particularly preferred that this has a through-opening through which the one head restraint rod or the one head restraint rod section is guided.

According to embodiments of the head restraint according to the disclosure, it is provided in this context that a wall region of the passage opening facing the push button has a complementary contour which is at least partially or partially adapted to the shaping, in particular cross-sectional shaping, of the one head restraint rod or of the one head restraint rod section.

In advantageous implementations of the head restraint according to the disclosure, it is provided that the locking mechanism has a guide body, which is designed in particular as a plastic part and preferably as an injection-molded plastic part, with a channel region extending in a first direction, wherein the one head restraint rod or the one head restraint rod section is guided in the channel region of the guide body extending in the first direction.

In this context, it makes sense for the guide body to have a receiving area in which the engagement element with the pretensioning element is at least partially or partially accommodated so that it can be displaced relative to the guide body in a second direction running at least essentially perpendicular to the first direction.

In embodiments of this design of the headrest according to the disclosure, it is provided that the receiving region of the guide body is assigned a guide, in particular in the form of at least one guide groove, with the aid of which the engagement element is guided so as to be displaceable in the second direction relative to the guide body.

It is also conceivable that the receiving area of the guide body has a window area in which the push-button and, in particular, a housing and/or cage structure assigned to the push-button, in which the push-button is at least partially or partially received, is received.

In this respect, it is advantageous that the window area of the receiving area of the guide body has a shape, at least in part or in some areas, which is at least substantially complementary to the shape of an area of the housing and/or cage structure associated with the pushbutton to be received in the window area.

In this context, it is useful for the housing and/or cage structure associated with the pushbutton to have at least one latching means, in particular in the form of a latching section, which is designed to latch behind a projecting region of the receiving region of the guide body in a state of the housing and/or cage structure associated with the pushbutton when it is received in the window region.

The headrest guide arrangement preferably has a first guide sleeve body, which is assigned to a first headrest rod or a first headrest rod section of the two headrest rods or the two headrest rod sections, and in which the first headrest rod or the first headrest rod section is accommodated or can be accommodated at least partially or in regions.

In the same way, it is also suitable for the headrest guide arrangement to have a second guide sleeve body which is assigned to a second headrest rod or a second headrest rod section of the two headrest rods or the two headrest rod sections, and in which the second headrest rod or the second headrest rod section is accommodated or can be accommodated at least partially or in a region.

In this context, it is conceivable that the channel region of the guide body extending in the first direction is designed to at least partially or partially accommodate at least one end region of the first guide sleeve body.

Preferably, the headrest guide arrangement has a tolerance compensation to compensate for any tolerance fluctuations between the distances between the two headrest rods or headrest rod sections, which run at least essentially parallel.

In this context, it is conceivable that the tolerance compensation has a bridge area connecting the first guide sleeve body to the second guide sleeve body, whereby the length of the bridge area is variable—at least over a predetermined or determinable distance.

According to a realization of the last-mentioned embodiment variant, it is provided that the bridge area has a first arm section which is connected to the first guide sleeve body, in particular integrally, and a second arm section which is connected to the second guide sleeve body, in particular integrally, whereby an end area of the first arm section facing the second arm section is resiliently connected to an end area of the second arm section facing the first arm section in the longitudinal direction of the bridge area. A compression spring is preferably used for this purpose. In particular, the two end regions of the arm sections can preferably be connected to each other in a telescopic manner.

According to embodiments of the headrest according to the disclosure, it is provided that the first guide sleeve body is accommodated or can be accommodated at least partially or in a region in a first receptacle designed in or on the seat back of the vehicle seat. In the same way, the second guide sleeve body can be accommodated or can be accommodated at least partially or in a region in a second receptacle designed in or on the seat back of the vehicle seat.

To compensate for any tolerance fluctuations between the distances between the two headrest rods or headrest rod sections, which run at least substantially parallel, the first receptacle has a cross-sectional geometry and size as tolerance compensation which corresponds to the cross-sectional geometry and size of the first guide sleeve. To compensate for any tolerance variations between the two at least substantially parallel head restraint rod sections, the first receptacle has a cross-sectional geometry and size that corresponds to the cross-sectional geometry and size of the first guide sleeve, while the second receptacle has an elongated hole-shaped cross-sectional geometry, with the longitudinal sides of the elongated hole extending in the direction of the first receptacle and the narrow sides of the elongated hole being terminated by semicircles whose diameter corresponds to the width of the elongated hole and is adapted to the size and cross-sectional geometry of the second guide sleeve.

Alternatively or additionally, it is conceivable that the first guide sleeve body has an inner axial passage which is designed to receive at least partially or in some areas the first head restraint rod or the first head restraint rod section, wherein the second guide sleeve body also has an inner axial passage which is designed to receive at least partially or in some areas the second head restraint rod or the second head restraint rod section.

To compensate for any existing diameter tolerances, the axial passage of the first guide sleeve body should have a cross-sectional geometry and size that corresponds to the cross-sectional geometry and size of the first headrest rod or the first headrest rod section, while the axial passage of the second guide sleeve body has an elongated hole-shaped cross-sectional geometry at least in some areas, with the longitudinal sides of the elongated hole extending in the direction of the first headrest rod section. of the first head support rod or the first head support rod section, while the axial passage of the second guide sleeve body has an elongated hole-shaped cross-sectional geometry at least in some areas, with the longitudinal sides of the elongated hole extending in the direction of the first guide sleeve body and the narrow sides of the elongated hole being terminated by semicircles whose diameter corresponds to the width of the elongated hole and is adapted to the size and cross-sectional geometry of the second head support rod or the second head support rod section.

However, an egg-shaped cross-sectional geometry or similar is also conceivable as an alternative to an elongated hole-shaped cross-sectional geometry.

Preferably, a diameter tolerance compensation for the corresponding headrest rod or for the corresponding headrest rod section is assigned to the two guide sleeve bodies. In this case, it is suitable for the diameter tolerance compensation to have at least one resilient element, which is arranged on the outer surface or inner surface of the first or second guide sleeve body. The at least one resilient element can be designed as an elastomer element.

In particular, it is therefore conceivable that the diameter tolerance compensation has at least one elastomeric area, which is formed on the outer surface and/or inner surface of the first or second guide sleeve body, in particular using a 2K plastic injection molding technique.

According to implementations of the disclosure, it is provided that at least the first guide sleeve body has a window region formed between the respective end regions of the first guide sleeve body.

In the following, with reference to the accompanying drawings, embodiments of the head restraint or head restraint guide arrangement according to the disclosure are described in more detail.

The exemplary embodiments of the head restraint 1 or the head restraint guide arrangement according to the disclosure, as shown in the accompanying drawings, are wherein a manually operable locking mechanism 3 is used, which can be transferred between a first state and a second state, the first state of the locking mechanism 3 corresponding to a locking state in which adjustability of the head restraint rods 2.1, 2.2 relative to the head restraint guide arrangement is blocked, and wherein the second state of the locking mechanism 3 corresponds to an unlocked state in which the head restraint rods 2.1, 2.2 can be adjusted relative to the head restraint guide arrangement. In this case, the manually operable locking mechanism 3 in its first state acts exclusively on only one of the two head restraint rods 2.1, 2.2 of the head restraint 1

For this purpose, the locking mechanism 3 has an engagement element 4 which, in the first state of the locking mechanism 3, is in engagement with one of the two headrest rods 2.1, 2.2. Furthermore, the locking mechanism 3 comprises a pretensioning element 6 (spring), which pretensions the locking mechanism 3 into its first state.

The embodiments of the headrest arrangement according to the disclosure shown in the drawings are further characterized by the fact that the locking mechanism 3 has a push button 7, which is designed in such a way that when the push button 7 is actuated, the locking mechanism 3 is transferred to its second state and an engagement between the engagement element 4 and the one headrest rod 2.1 is released. The aforementioned pretensioning element 6 also serves to pretension the push button 7 into its non-actuated position.

In the embodiments shown in the drawings, a spring arm, in particular a V-shaped spring arm, is used as the pretensioning element 6, which is designed or arranged on a side of the engagement element 4 opposite the push button 7.

In the embodiment shown in FIG. 1, the engagement element 4 and the push button 7 are designed as a monolithic plastic injection-molded unit. In principle, it is conceivable that the spring element 6 is also an integral part of this plastic injection-molded unit.

In the embodiments shown in FIG. 3 to FIG. 6, on the other hand, the push button 7 is detachably or replaceably connected to the engagement element 4, in particular via a positive connection, preferably a latching connection. The exploded view according to FIG. 5 shows that for this purpose the push button 7 is accommodated in a corresponding housing or cage area 8 so that it can be moved longitudinally.

In particular, it can be seen from the representation in FIG. 1 that the engagement element 4 in this embodiment of the headrest arrangement according to the disclosure has a through-opening 5 through which the one headrest rod 2.1 is guided, wherein a wall region of the through-opening 4 facing the push-button 7 has a complementary contour which is at least partially or partially adapted to the shape, in particular the cross-sectional shape, of the one headrest rod 2.1.

The headrest guide arrangements of the embodiments shown in the drawings each have a first guide sleeve body 9.1 and a second guide sleeve body 9.2. The first guide sleeve body 9.1 is assigned to a first head restraint rod 2.1 of the two head restraint rods 2.1, 2.2, wherein the first head restraint rod 2.1 is accommodated or can be accommodated in the first guide sleeve body 9.1 at least in part or in a region.

In the same way, the second guide sleeve body 9.2 is assigned to a second head restraint rod 2.2 of the two head restraint rods 2.1, 2.2, wherein the second head restraint rod 2.2 is accommodated or can be accommodated in the second guide sleeve body 9.2 at least in part or in a region.

In the embodiment shown in FIG. 1, the headrest guide arrangement has a tolerance compensation to compensate for any existing tolerance fluctuations between the distances between the two headrest rods 2.1, 2.2, which run at least substantially parallel.

In detail, the tolerance compensation comprises a bridge area 11 connecting the first guide sleeve body 9.1 with the second guide sleeve body 9.2, whereby the length of the bridge area 11 is variable—at least over a predetermined or determinable distance.

As can be seen in particular from the illustration in FIG. 2, the bridge region 11 has a first arm section 12.1, which is connected to the first guide sleeve body 9.1, in particular integrally. In addition, the bridge area 11 comprises a second arm section 12.2, which is connected to the second guide sleeve body 9.1, 9.2, in particular integrally. An end region of the first arm section 12.1 facing the second arm section 12.2 is resiliently connected to an end region of the second arm section 12.2 facing the first arm section 12.1 in the longitudinal direction of the bridge region 11.

A compression spring 13, preferably integrated in the second arm section 12.2, is used for this purpose. The two end regions of the arm sections 12.1, 12.2 can preferably be connected to each other in a telescopic manner.

Alternatively or in addition to such a bridge area 11 serving as tolerance compensation, it is also conceivable that—as indicated in FIG. 3—the first guide sleeve body 9.1 has an inner axial passage which is designed to receive the first head support rod 2.1 at least partially or in certain areas, whereby the second guide sleeve body 9.2 has an inner axial passage which is designed to receive the second head support rod 2.2 at least partially or in certain areas, wherein, in order to compensate for existing diameter tolerances and/or to compensate for any existing tolerance fluctuations between the distances between the two at least substantially parallel head support rods 2.1, 2.2, the axial passage of the first guide sleeve body 9.1 has a cross-sectional geometry and size which corresponds to the cross-sectional geometry and size of the first head support rod 2.1, whereas the axial passage of the second guide sleeve body 9.2 has a cross-sectional geometry that is at least substantially elongated at least in some areas, with the longitudinal sides of the elongated hole extending in the direction of the first guide sleeve body 9.1 and the narrow sides of the elongated hole being terminated by semicircles whose diameter corresponds to the width of the elongated hole and is adapted to the size and cross-sectional geometry of the second headrest rod 2.2.

In the embodiments shown in the drawings, the guide sleeve bodies 9.1, 9.2 of the headrest guide arrangements are designed with an integrated diameter tolerance compensation. In detail, the diameter tolerance compensation is formed by at least one resilient element 10 or elastomer area 20, which is formed on the outer surface or inner surface of the corresponding guide sleeve body 9.1, 9.2.

In the following, reference is made in particular to the embodiments shown in FIG. 7A, B and FIG. 8A-C.

As shown, the locking device 3 can have a guide body 14 designed in particular as a plastic part and preferably as an injection-molded plastic part with a channel region 15 extending in a first direction, wherein the one headrest rod 2.1, 2.2 or the one headrest rod section is guided in the channel region (15) of the guide body 14 extending in the first direction.

The guide body 14 has a receiving area in which the engagement element 4 with the pre-tensioning element 6 is at least partially or regionally received so as to be displaceable relative to the guide body 14 in a second direction extending at least substantially perpendicular to the first direction.

In particular, it is provided that the receiving area of the guide body 14 is assigned a guide 16, in particular in the form of at least one guide groove, by means of which the engagement element 4 is guided so as to be displaceable in the second direction relative to the guide body 14.

It can also be seen from the representation, in particular in FIG. 7B, that the receiving region of the guide body 14 has a window region in which the push-button 7 and, in particular, a housing and/or cage structure 8 associated with the push-button 7, in which the push-button 7 is at least partially or partially received, is received.

In this context, it is conceivable in particular that the window area of the receiving area of the guide body 14 has a shape that is at least partially or partially complementary to the shape of an area of the housing and/or cage structure 8 associated with the pushbutton 7 to be received in the window area.

Furthermore, it is indicated in particular in FIG. 7B that the housing and/or cage structure 8 associated with the pushbutton 7 has at least one latching means 17, in particular in the form of a latching section, which is designed to latch behind a projecting region of the receiving region of the guide body 14 in a state of the housing and/or cage structure 8 associated with the pushbutton 7 received in the window region.

The illustrations in FIG. 7A, B and FIG. 8A-C show that the diameter tolerance compensation of the first guide sleeve body 9.1 has at least one elastomeric region, which is formed on the outer surface and/or inner surface of the first guide sleeve body 9.1, in particular by means of a 2K plastic injection molding technique.

It can also be seen that the first guide sleeve body 9.1 has a window region 19 formed between the respective end regions of the first guide sleeve body 9.1.

The disclosure is not limited to the embodiments shown in the drawings, but results from a synopsis of all the features disclosed herein.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### LIST OF REFERENCE SYMBOLS

1 Headrest
2.1 First Headrest Bar
2.2 Second Headrest Bar
3 Locking
4 Intervention Element
5 Passage Opening In The Engagement Element
6 Preload Element
7 Push Button
8 Housing/Cage Structure
9.1 First Guide Sleeve Body
9.2 Second Guide Sleeve Body
Resilient Element/Elastomer Element
11 Bridge Area
12.1 First Arm Section
12.2 Second Arm Section
13 Spring/Compression Spring
14 Guide Body
15 Channel Area
16 Guidance
17 Detent
18 Projecting Area
19 Window Area
20 Elastomer Area

What is claimed is:

1. A headrest (1) for a vehicle seat comprising:
two at least substantially parallel headrest rods (2.1, 2.2) or headrest rod sections, on which a head cushion of the headrest (1) is arranged or can be arranged;
a head restraint guide arrangement, by means of which the head restraint rods (2.1, 2.2) or head restraint rod sections are accommodated or can be accommodated on and in a seat back of the vehicle seat in such a way that the head restraint rods (2.1, 2.2) or head restraint rod sections are connected to the head cushion of the head restraint (1), which may be arranged on the head restraint rods (2.1, 2.2) or head restraint rod sections, in a longitudinal extension direction of the head restraint rods (2.1, 2.2) or head restraint rod sections. the headrest rods (2.1, 2.2) or headrest rod sections are adjustable and displaceable relative to the headrest guide arrangement between a first position and at least one second position; and
a locking mechanism (3) which can be actuated, manually, and which can be transferred between a first state and a second state, the first state of the locking mechanism (3) corresponding to a locked state in which adjustability of the head restraint rods (2.1, 2.2) or head restraint rod sections relative to the head restraint guide arrangement is blocked, and the second state of the locking mechanism (3) corresponding to an unlocked state in which adjustability of the head restraint rod sections relative to the head restraint guide arrangement is blocked, and The first state of the locking mechanism (3) corresponds to a locked state in which the head restraint rods (2.1, 2.2) or head restraint rod sections are blocked relative to the head restraint guide arrangement, and the second state of the locking mechanism (3) corresponds to an unlocked state in which the head restraint rods (2.1, 2.2) or head restraint rod sections can be adjusted relative to the head restraint guide arrangement,
wherein the locking mechanism (3), which can be actuated manually, acts exclusively on only one of the two headrest rods (2.1, 2.2) or headrest rod sections, especially in its first state.

2. The headrest (1) according to claim 1, wherein the locking device (3), which can be actuated manually, has an engagement element (4), which in the first state of the locking device (3) is in engagement with one of the two headrest rods (2.1, 2.2) or with one of the two headrest rod sections, and a pretensioning element (6), which pretensions the locking device (3) into its first state.

3. The headrest (1) according to claim 2,
wherein the locking device (3), which can be actuated manually, has a push button (7) which is designed in such a way that when the push button (7) is actuated, the locking device (3) is transferred to its second state and an engagement between the engagement element (4) and the one headrest rod (2.1, 2.2) or the one headrest rod section is released.

4. The headrest (1) according to claim 3,
wherein the pretensioning element (6) is designed to pretension the pushbutton (7) into its unactuated position.

5. The headrest (1) according to claim 3,
wherein the pretensioning element (6) is designed as a spring arm, which is integral with the engagement element (4) and which is designed or arranged on a side of the engagement element opposite the push button (7).

6. The headrest (1) according to claim 3,
wherein the engagement element (4) and the pushbutton (7) are designed as a monolithic plastic injection-molded structural unit, and wherein the engagement element (4), the pushbutton (7) and the pretensioning element (6) are designed as a monolithic plastic injection-molded structural unit.

7. The headrest (1) according to claim 3, wherein the push button (7) is detachably and/or replaceably connected or connectable to the engagement element (4) via a positive connection.

8. The headrest (1) according to claim 2, wherein the engagement element (4) has a through opening (5) through which the one head restraint rod (2.1, 2.2) or the one head restraint rod section is guided, wherein a wall region of the through opening (5) facing the push button (7) has a complementary contour which is at least partially or regionally adapted to the shaping of the one head restraint rod (2.1, 2.2) or the one head restraint rod section.

9. The headrest (1) according to claim 2, wherein the locking device (3) has a guide body (14) designed as an injection-molded plastic part with a channel region (15) extending in a first direction, wherein the one headrest rod (2.1, 2.2) or the one headrest rod section is guided in the channel region (15) of the guide body (14) extending in the first direction.

10. The headrest (1) according to claim 9, wherein a receiving region is formed in the guide body (14), in which the engagement element (4) with the pretensioning element (6) is received at least partially or in certain regions in a second direction extending at least substantially perpendicular to the first direction so as to be displaceable relative to the guide body (14).

11. The headrest (1) according to claim 10, wherein a guide (16), in the form of at least one guide groove, is associated with the receiving region of the guide body (14), with the aid of which guide the engagement element (4) is displaceably guided in the second direction relative to the guide body (14).

12. The headrest (1) according to claim 3, wherein the receiving region of the guide body (14) has a window region in which the pushbutton (7) and a housing and/or cage structure (8) associated with the pushbutton (7), in which the pushbutton (7) is at least partially or partially received, is received.

13. The headrest (1) according to claim 12,
wherein the window region of the receiving region of the guide body (14) has, at least in part or in regions, a shape which is at least substantially complementary to the shape of a region, to be received in the window region, of the housing and/or cage structure (8) associated with the push-button (7).

14. The headrest (1) according to claim 13,
wherein the housing and/or cage structure (8) associated with the push-button (7) has at least one latching means (17) in the form of a latching portion, which is designed to latch behind a projecting region of the receiving region of the guide body (14) in a state of the housing and/or cage structure (8) associated with the push-button (7) received in the window region.

15. The headrest (1) according to claim 9,
wherein the headrest guide arrangement has a first guide sleeve body (9.1), which is associated with a first headrest rod (2.1) or a first headrest rod section of the two headrest rods (2.1, 2.2) or the two headrest rod sections, and in which the first headrest rod (2.1) or the first headrest rod section is accommodated or can be accommodated at least partially or in regions; and
wherein the headrest guide arrangement has a second guide sleeve body (9.2), which is associated with a second headrest rod (2.2) or a second headrest rod section of the two headrest rods (2.1, 2.2) or the two headrest rod sections, and in which the second headrest rod (2.2) or the second headrest rod section is accommodated or can be accommodated at least partially or in regions.

16. The headrest (1) according to claim 15,
wherein the channel region (15) of the guide body (14) extending in the first direction is designed to at least partially or partially receive at least one end region of the first guide sleeve body (9.1).

17. The headrest (1) according to claim 15, wherein the headrest guide arrangement comprises a tolerance compensation for compensating any tolerance variations between the distances of the two at least substantially parallel headrest rods (2.1, 2.2) or headrest rod sections.

18. The headrest (1) according to claim 17,
wherein the tolerance compensation has a bridge region (11) connecting the first guide sleeve body (9.1) to the second guide sleeve body (9.2), wherein the length of the bridge region (11) is variable—at least over a predetermined or determinable distance.

19. The headrest (1) according to claim 18,
wherein the bridge region (11) has a first arm section (12.1), which is connected to the first guide sleeve body (9.1), and has a second arm section (12.2), which is connected to the second guide sleeve body (9.2), wherein an end region of the first arm section (12.1) facing the second arm section (12.2) is connected to an end region of the second arm section (12.2) facing the first arm section (12.1) in the longitudinal direction of the bridge region.2) is resiliently connected to an end region of the second arm section (12.2) facing the first arm section (12.1) in the longitudinal direction of the bridge region (11), wherein the two end regions of the arm sections (12.1, 12.2) are connected to one another in a telescopic manner.

20. The headrest (1) according to claim 15, wherein the first guide sleeve body (9.1) is received or can be received at least partially or in regions in a first receptacle designed in or on the seat back of the vehicle seat, wherein the second guide sleeve body (9.2) is accommodated or can be accommodated at least partially or in certain regions in a second receptacle designed in or on the seat back of the vehicle seat, wherein, in order to compensate for any tolerance fluctuations between the distances between the two headrest rods (2.1, 2.2) or headrest rod sections running at least substantially parallel as tolerance compensation, the first receptacle has a cross-sectional geometry and size which corresponds to the cross-sectional geometry and size of the first guide sleeve, while the second receptacle has an elongated hole-shaped cross-sectional geometry, the longitudinal sides of the elongated hole extending in the direction of the first receptacle and the narrow sides of the elongated hole being terminated by semicircles, the diameter of which corresponds to the width of the elongated hole and is adapted to the size and cross-sectional geometry of the second guide sleeve.
